(19) United States
(12) Patent Application Publication
(10) Pub. No.: US 2026/0208264 A1
(43) Pub. Date: Jul. 23, 2026

(54) MANUFACTURING METHOD FOR MAGNETIC MOLDED BODY AND MANUFACTURING METHOD FOR ANISOTROPIC BOND MAGNET

(71) Applicant: Resonac Corporation, Minato-ku, Tokyo (JP)

(72) Inventors: Arisa TAIRA, Tokyo (JP); Kazumasa TAKEUCHI, Tokyo (JP); Teruo ITOH, Tokyo (JP)

(21) Appl. No.: 19/141,378

(22) PCT Filed: Dec. 26, 2022
(86) PCT No.: PCT/JP2022/048013

§ 371 Date: Jun. 20, 2025

(51) Int. Cl. B22F 3/14; B22F 3/24; H01F 1/059; H01F 1/08; H01F 13/00

(52) U.S. Cl. CPC B22F 3/14; B22F 3/24; H01F 1/059; H01F 1/083; H01F 1/086; H01F 13/006; B22F 2998/10

(57) ABSTRACT

A manufacturing method for a magnetic compact includes a supplying step of supplying a compound containing a magnetic powder, a thermosetting resin, and a wax into a mold, a molding step of forming a compact from the compound and removing the wax from the compact by compressing the compound in the mold while applying a magnetic field to the compound in the mold heated at a molding temperature Tm, a demagnetizing step of demagnetizing the compact after the molding step, and a thermal curing step of heating the compact at a temperature equal to or higher than a thermal curing temperature of the thermosetting resin after the demagnetizing step to obtain a magnetic compact. The magnetic powder contains a Sm—Fe—N based permanent magnet. The molding temperature Tm is equal to or higher than a dropping point of the wax and lower than the thermal curing temperature of the thermosetting resin.

### TECHNICAL FIELD

The present disclosure relates to a manufacturing method for a magnetic compact and a manufacturing method for an anisotropic bond magnet.

### BACKGROUND ART

A Sm—Fe—N based permanent magnet (samarium-iron-nitrogen based permanent magnet) can be manufactured from a cheaper raw material than other rare earth magnets such as a Nd—Fe—B based permanent magnet (neodymium-iron-boron based permanent magnet), and has excellent magnetic characteristics. However, it is difficult to manufacture a sintered magnet from the Sm—Fe—N based permanent magnet because the crystal structure of the Sm—Fe—N based permanent magnet is likely to deteriorate at a high temperature (about 500° C.). Therefore, the Sm—Fe—N based permanent magnet is used as a raw material of an anisotropic bond magnet that can be manufactured by heating (thermal curing of a thermosetting resin mixed with a magnetic powder) at a low temperature at which a crystal structure is maintained.

As a raw material of the anisotropic bond magnet, a compound containing a magnetic powder (a large number of magnetic particles containing permanent magnets) and a thermosetting resin is used. In a manufacturing of the anisotropic bond magnet, the compound is fed into a mold. A compact is formed from the compound by compressing the compound with the mold while a magnetic field generated by a coil is applied to the compound in the mold. Each magnetic particle (magnetic domain in each magnetic particle) in the compact is magnetized and oriented along the magnetic field. The compact is demagnetized, the demagnetized compact is cured by heating, and the cured compact is magnetized to obtain an anisotropic bond magnet. Residual magnetic flux density (Br), which is one of the important magnetic characteristics of the anisotropic bond magnet, is improved by an orientation of the magnetic powder in the compact and an increase in a filling rate of the magnetic powder in the compact.

In addition to the above-described manufacturing method, various manufacturing methods using the Sm—Fe—N based permanent magnet have been known. For example, Patent Literature 1 below discloses a method for manufacturing a magnet compact having a high residual magnetic flux density by cold compaction molding a Sm—Fe—N-based magnetic powder containing a metal binder (Zn, Cu, or the like) at a high pressure (1 to 5 GPa). Patent Literature 2 below discloses a method for manufacturing a bond magnet from a compound containing a Sm—Fe—N-based magnetic powder and a thermosetting resin with a low-viscosity. Patent Literature 3 below discloses a compound containing a Sm—Fe—N-based magnetic powder, an epoxy resin, and wax as a raw material for a bond magnet.

### CITATION LIST

### Patent Literature

Patent Literature 1: Japanese Unexamined Patent Publication No. 2016-82175
Patent Literature 2: Japanese Unexamined Patent Publication No. 2021-127515
Patent Literature 3: International Publication WO 2019/106813
Patent Literature 4: Japanese Unexamined Patent Publication No. 2019-48948

### SUMMARY OF INVENTION

### Technical Problem

A magnetic powder containing a Sm—Fe—N based permanent magnet can have anisotropy. That is, each magnetic particle (magnetic domain in each magnetic particle) constituting the magnetic powder containing the Sm—Fe—N based permanent magnet can have an easy magnetization axis (crystal axis) extending in one direction. Therefore, in a case where the magnetic powder contains the Sm—Fe—N based permanent magnet, in a compression process of a compound to which a magnetic field is applied, each magnetic particle in the compound is rotated by the magnetic field, and the easy magnetization axis of each magnetic particle (each magnetic domain) is easily oriented along the direction of the magnetic field. As a result, an anisotropic bond magnet having a high residual magnetic flux density can be obtained. However, as the viscosity of a thermosetting resin in the compound is higher, each magnetic particle in the compound is difficult to be rotated by the magnetic field, and the easy magnetization axis of each magnetic particle (each magnetic domain) is difficult to be oriented along the direction of the magnetic field. Even in a case where the viscosity of the thermosetting resin in the compound is high, by using a high-intensity pulsed magnetic field, each magnetic particle in the compound is rotated by the magnetic field. However, a large magnetic field generator is required for generating a pulsed magnetic field. On the other hand, in a case where a static magnetic field (continuous constant magnetic field) generated by a small magnetic field generator is used, it is difficult to sufficiently orient the easy magnetization axis of each magnetic particle in the compound along the magnetic field.

In a case where the compound contains wax in addition to the magnetic powder and the thermosetting resin, each magnetic particle in the compound easily rotates due to lubricity of the wax. However, unlike the thermosetting resin (binder), the wax is not cured by heating and does not bind the magnetic particles to each other. Therefore, as the content of the wax in the compound increases, mechanical strength of a compact formed from the compound decreases, and mechanical strength of an anisotropic bond magnet also decreases. For example, the mechanical strength may be paraphrased as crushing strength or radial crushing strength.

An object of an aspect of the present invention is to provide a manufacturing method for a magnetic compact used for manufacturing an anisotropic bond magnet excellent in residual magnetic flux density and mechanical strength, and a manufacturing method for an anisotropic bond magnet excellent in residual magnetic flux density and mechanical strength.

### Solution to Problem

For example, an aspect of the present invention relates to a manufacturing method for a magnetic compact according to any one of [1] to [8] as follows and a manufacturing method for an anisotropic bond magnet according to [9] as follows.

[1] A manufacturing method for a magnetic compact, the method including:
a supplying step of supplying a compound containing a magnetic powder, a thermosetting resin, and a wax into a mold;
a molding step of forming a compact from the compound and removing the wax from the compact by compressing the compound in the mold while applying a magnetic field to the compound in the mold heated at a molding temperature Tm;
a demagnetizing step of demagnetizing the compact after the molding step; and
a thermal curing step of heating the compact at a temperature equal to or higher than a thermal curing temperature of the thermosetting resin after the demagnetizing step to obtain the magnetic compact from the compact,
wherein the magnetic powder contains a Sm—Fe—N based permanent magnet, and
the molding temperature Tm is equal to or higher than a dropping point of the wax and lower than the thermal curing temperature of the thermosetting resin.

[2] The manufacturing method for a magnetic compact according to [1],
wherein the molding step includes a first pressurizing step and a second pressurizing step subsequent to the first pressurizing step,
in the first pressurizing step, a pressure acting on the compound in the mold heated at the molding temperature Tm is maintained at a first pressure P1,
in the second pressurizing step, a pressure acting on the compound in the mold heated at the molding temperature Tm is maintained at a second pressure P2,
the second pressure P2 is higher than the first pressure P1, and
in the second pressurizing step, the wax is removed from the compact.

[3] The manufacturing method for a magnetic compact according to [1],
wherein, in the molding step, the wax is removed from the compact by continuously increasing a pressure acting on the compound in the mold heated at the molding temperature Tm to a second pressure P2.

[4] The manufacturing method for a magnetic compact according to any one of [1] to [3], the method further including
a cooling step of cooling the mold in which the compact is contained from the molding temperature Tm to a temperature lower than the dropping point,
wherein, the cooling step is subsequent to the molding step, and
the demagnetizing step is performed after the cooling step.

[5] The manufacturing method for a magnetic compact according to any one of [1] to [4],
wherein a clearance is formed in the mold,
a viscosity of the wax at the molding temperature Tm is lower than a viscosity of the thermosetting resin at the molding temperature Tm, and
in the molding step, the wax removed from the compact is discharged to an outside of the mold through the clearance.

[6] The manufacturing method for a magnetic compact according to any one of [1] to [5],
wherein a total of a mass of the magnetic powder and a mass of the thermosetting resin is represented by M1,
a mass of the wax in the compound is represented by M2, and
(M2/M1)×100 is 2 or more and 10 or less.

[7] The manufacturing method for a magnetic compact according to any one of [1] to [6],
wherein the thermosetting resin contains at least one resin selected from the group consisting of an epoxy resin, a maleimide compound, polyimide, polyamide, and polyamideimide.

[8] The manufacturing method for a magnetic compact according to any one of [1] to [7],
wherein the wax contains a montanic acid ester.

[9] A manufacturing method for an anisotropic bond magnet, the method including:
the manufacturing method for a magnetic compact according to any one of [1] to [8]; and
further including a magnetizing step of magnetizing the magnetic compact to obtain the anisotropic bond magnet.

That is, the manufacturing method for the anisotropic bond magnet according to an aspect of the present invention includes:
a supplying step of supplying a compound containing a magnetic powder, a thermosetting resin, and a wax into a mold;
a molding step of forming a compact from the compound and removing the wax from the compact by compressing the compound in the mold while applying a magnetic field to the compound in the mold heated at a molding temperature Tm;
a demagnetizing step of demagnetizing the compact after the molding step;
a thermal curing step of heating the compact at a temperature equal to or higher than a thermal curing temperature of the thermosetting resin after the demagnetizing step to obtain a magnetic compact from the compact; and
a magnetizing step of magnetizing the magnetic compact to obtain the anisotropic bond magnet,
wherein the magnetic powder contains a Sm—Fe—N based permanent magnet, and
the molding temperature Tm is equal to or higher than a dropping point of the wax and lower than the thermal curing temperature of the thermosetting resin.

### Advantageous Effects of Invention

According to an aspect of the present invention, it is possible to provide a manufacturing method for a magnetic compact used for manufacturing an anisotropic bond magnet excellent in residual magnetic flux density and mechanical strength, and a manufacturing method for an anisotropic bond magnet excellent in residual magnetic flux density and mechanical strength.

### BRIEF DESCRIPTION OF DRAWINGS

(a) in FIG. 1 and (b) in FIG. 1 are schematic cross-sectional views of a manufacturing apparatus used in a manufacturing method for a magnetic compact according to an embodiment of the present invention, and the cross sections illustrated in (a) in FIG. 1 and (b) in FIG. 1 cross all of a pair of punches, a die, a compound, and a pair of coils, and are parallel to a direction (pressurizing direction) of pressure exerted on the compound by the pair of punches.

FIG. 2 is a graph showing the change in a temperature of a mold over time in a molding step and the change in a pressure acting on the compound in the mold over time in the molding step.

FIG. 3 is another graph showing the change in a temperature of the mold over time in the molding step and the change in a pressure acting on the compound in the mold over time in the molding step.

FIG. 4 is a schematic cross-sectional view of a magnetic compact (or an anisotropic bond magnet) according to the embodiment of the present invention.

### DESCRIPTION OF EMBODIMENTS

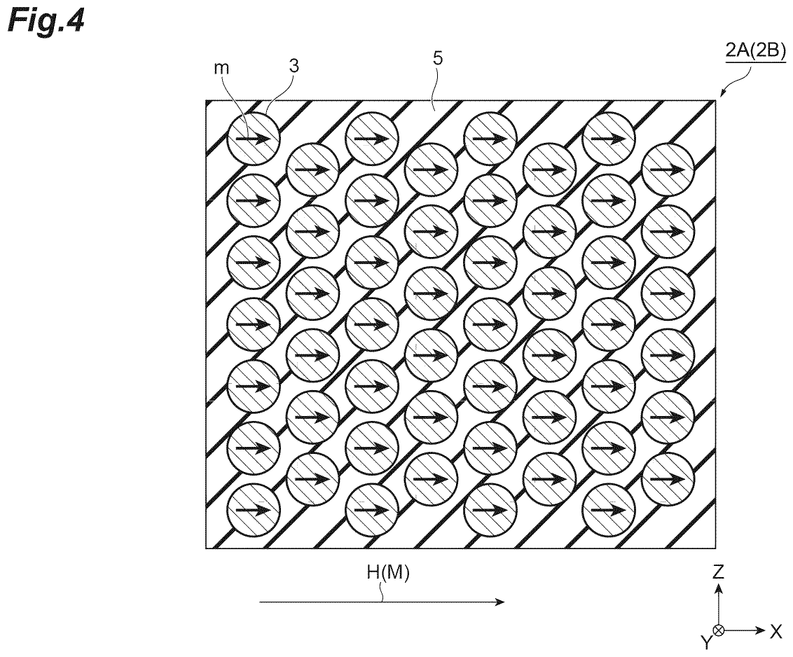

Hereinafter, a preferred embodiment of the present invention will be described with reference to the drawings. In the drawings, the same components are indicated by the same reference numerals. The present invention is not limited to the following embodiments. X, Y, and Z illustrated in (a) in FIG. 1, (b) in FIG. 1, and FIG. 4 mean three coordinate axes orthogonal to each other. The directions of the X axis, the Y axis, and the Z axis are common to (a) in FIG. 1, (b) in FIG. 1, and FIG. 4.

### (Manufacturing Apparatus)

(a) in FIG. 1 and (b) in FIG. 1 illustrate schematic cross sections of a manufacturing apparatus 10 (molding apparatus) used in a manufacturing method for a magnetic compact according to the present embodiment.

The manufacturing apparatus 10 includes a pair of punches (a first punch p1 and a second punch p2) facing each other, and a cylindrical die d1 into which the pair of punches is inserted. A first opening portion is formed on an end surface of the die d1 facing the first punch p1, and the first punch p1 is inserted into the first opening portion. A second opening portion is formed on an end surface of the die d1 facing the second punch p2, and the second punch p2 is inserted into the second opening portion. A cavity (negative mold) includes the second punch p2 inserted into the die d1 and the die d1. The first punch p1 functions as a core (positive mold). That is, a set of molds is formed by the pair of punches (the first punch p1 and the second punch p2) facing each other, and the cylindrical die d1 into which the pair of punches is inserted.

A compound 2, which is a raw material of a magnetic compact and an anisotropic bond magnet, is supplied into the cavity including the second punch p2 and the die d1 (see (a) in FIG. 1). The compound 2 in the cavity is held between the first punch p1 and the second punch p2, and pressurized and compressed by the first punch p1 and the second punch p2 (see (b) in FIG. 1). The direction of pressure (pressurizing direction) exerted on the compound 2 by each of the first punch p1 and the second punch p2 is parallel to the Z axis. In the present embodiment, the “pressure acting on the compound in the mold” is the pressure exerted on the compound 2 by each of the first punch p1 and the second punch p2. The “pressure acting on the compound in the mold” is denoted as a molding pressure P.

A clearance 6 is formed in the mold. For example, the clearance 6 is formed between side surface of each of the first punch p1 and second punch p2, and the inner wall of the die d1. Due to the clearance 6, the side surface of each of the first punch p1 and second punch p2 easily slides on the inner wall of the die d1. As described later, a part or all of the wax 4 in the compound 2 is discharged to the outside of the mold (cavity) through the clearance 6 in the molding step. The width of the clearance 6 is sufficiently small, and a magnetic powder and a thermosetting resin in the compound 2 are not discharged to the outside of the mold through the clearance 6. For example, the width of the clearance 6 may be less than the particle size of each magnetic particle constituting the magnetic powder. The position where the clearance 6 is formed in the mold is not limited as long as the inside of the mold (cavity) communicates with the outside of the mold via the clearance 6.

The dimension and shape of each of the first punch p1, the second punch p2, and the die d1 is not limited. For example, the dimension and shape of each of the first punch p1, the second punch p2, and the die d1 may be changed according to the desired dimension and shape of the magnetic compact or the anisotropic bond magnet. A composition of each of the first punch p1, the second punch p2, and the die d1 is not limited. For example, each of the first punch p1, the second punch p2, and the die d1 may contain a metal having sufficient mechanical strength as a mold.

The manufacturing apparatus 10 includes a pair of coils (a first coil c1 and a second coil c2). The die d1 and the compound 2 in the die d1 are disposed between the pair of coils (the first coil c1 and the second coil c2). The first punch p1 and the second punch p2 do not penetrate the inner side of each of the pair of coils (the first coil c1 and the second coil c2).

The manufacturing apparatus 10 further includes a power supply mechanism. The power supply mechanism is electrically connected to each of the first coil c1 and the second coil c2. The power supply mechanism freely controls the direction and the absolute value of a first current generated in the first coil c1 and the direction and the absolute value of the second current generated in the second coil c2. The power supply mechanism is not illustrated in the drawings.

A magnetic field H may be synthesized from the magnetic field generated in the first coil c1 and the magnetic field generated in the second coil c2, and the synthesized magnetic field H may be applied to the compound 2 in the die d1. The magnetic field H generated by only one of the first coil c1 and the second coil c2 may be applied to the compound 2 in the die d1. Details of the magnetic field H will be described later.

The central axes of the first coil c1 and the second coil c2 coincide with each other and are parallel to the X axis. The magnetic field H generated by the first coil c1 and the second coil c2 is also parallel to the X axis. The direction of the magnetic field H is perpendicular to the pressurizing direction. That is, the magnetic field H perpendicular to the pressurizing direction is applied to the compound. However, the direction of the magnetic field H is not limited. The direction of the magnetic field H may be changed by changing the disposition of the first coil c1 and the second coil c2. For example, the first punch p1 may penetrate the inside of the first coil c1, the second punch p2 may penetrate the inside of the second coil c2, the die d1 may be disposed between the first coil c1 and the second coil c2, the central axes of the first coil c1 and the second coil c2 may coincide with each other, and the central axes of the first coil c1 and the second coil c2 may be parallel to the pressurizing direction. As a result, the magnetic field H parallel to the pressurizing direction may be applied to the compound 2.

The composition of each of the first coil c1 and the second coil c2 is not limited as long as each of the first coil c1 and the second coil c2 is a conductor. Each of the first coil c1 and the second coil c2 may be an air-core coil. An iron core (yoke) may be installed inside each of the first coil c1 and the second coil c2. The inner diameter and the number of windings (the number of turns) of each of the first coil c1 and the second coil c2 are not limited. The inner diameters of the first coil c1 and the second coil c2 may be the same as each other. The inner diameters of the first coil c1 and the second coil c2 may be different from each other. The number of windings of the first coil c1 and the number of windings of the second coil c2 may be the same as each other. The number of windings of the first coil c1 and the number of windings of the second coil c2 may be different from each other.

### (Manufacturing Method for Magnetic Compact and Manufacturing Method for Anisotropic Bond Magnet)

The manufacturing method for a magnetic compact according to the present embodiment includes a supplying step, a molding step, (a cooling step,) a demagnetizing step, and a thermal curing step. The manufacturing method for an anisotropic bond magnet according to the present embodiment includes the manufacturing method for a magnetic compact, and further includes a magnetizing step performed in the thermal curing step. That is, the manufacturing method for an anisotropic bond magnet according to the present embodiment further includes the magnetizing step in addition to the supplying step, the molding step, (the cooling step,) the demagnetizing step, and the thermal curing step. Hereinafter, details of each step will be described.

The “magnetic compact” is a compact, containing a magnetic powder and a cured product of a thermosetting resin, in which an easy magnetization axis in each magnetic particle (each magnetic domain in each magnetic particle) constituting the magnetic powder is oriented along a desired direction (a direction of a magnetic field in the molding step). The “anisotropic bond magnet” is a magnet, containing a magnetic powder and a cured product of a thermosetting resin, in which an easy magnetization axis in each magnetic particle (each magnetic domain in each magnetic particle) constituting the magnetic powder is oriented along a desired direction (a direction of a magnetic field in the molding step), each magnetic particle is magnetized in the desired direction, and the entire magnet is magnetized in the desired direction.

### <Supplying Step>

In the supplying step, the compound 2 containing the magnetic powder, the thermosetting resin, and the wax is supplied into the mold (cavity) (see (a) in FIG. 1). The magnetic powder can be rephrased as a large number of magnetic particles containing permanent magnets. The magnetic powder contains a Sm—Fe—N based permanent magnet. The magnetic powder may consist of only the Sm—Fe—N based permanent magnet. Details of the magnetic powder will be described later. The temperature of the compound itself supplied into the mold may be room temperature. The compound 2 may be solid at room temperature. For example, the compound 2 may be powder. Instead of the compound 2, a tablet containing the compound 2 may be supplied into the mold.

### <Molding Step>

In the molding step, the compound 2 in the mold is compressed while the magnetic field H is applied to the compound 2 in the mold heated at a molding temperature Tm (see (b) in FIG. 1). The wax in the compound 2 is liquefied because the molding temperature Tm is equal to or higher than the dropping point of the wax. Due to the lubricity of the liquefied wax, the magnetic particles easily slide against one another, each magnetic particle magnetized by the magnetic field H easily rotates, and the easy magnetization axis of the magnetic domain in each magnetic particle is oriented along the magnetic field H. In other words, each magnetic particle 3 is oriented in such a way that a magnetization direction m of each magnetic particle 3 is substantially parallel to the magnetic field H (see FIG. 4). In a case where each magnetic particle 3 is a single crystal grain (single magnetic domain), the magnetization direction m of each magnetic particle 3 is the same as the direction in which the easy magnetization axis of each magnetic particle extends. Since the molding temperature Tm is lower than the thermal curing temperature of a thermosetting resin 5, the thermal curing of the thermosetting resin is suppressed during the molding step, and the rotation and orientation of each magnetic particle 3 driven by the magnetic field H are less likely inhibited by the thermal curing of the thermosetting resin 5. As the compound 2 is compressed, a compact 2A containing a magnetic powder oriented along the magnetic field H and a thermosetting resin (uncured product) is formed. The magnetization direction M of the entire compact 2A before demagnetization is substantially parallel to the direction of the magnetic field H applied to the compound 2 in the molding step.

As described above, the compact 2A excellent in the orientation of the magnetic powder is obtained due to the lubricity of the wax during the molding step. The state in which the magnetic powder is oriented is also maintained in the magnetic compact obtained by demagnetization and thermal curing of the compact 2A. Therefore, an anisotropic bond magnet obtained by magnetization of the magnetic compact can have a high residual magnetic flux density caused by the excellent orientation of the magnetic powder. Furthermore, due to the compression of the compound 2 in the molding step (that is, an increase in the filling rate of the magnetic powder in the compact 2A), the residual magnetic flux density of the anisotropic bond magnet increases.

According to the present embodiment, even in a case where the viscosity of the thermosetting resin is high and the thermosetting resin inhibits the rotation and orientation of the magnetic particles, each magnetic particle can rotate and can be oriented due to the lubricity of the liquefied wax. Therefore, according to the present embodiment, it is possible to manufacture an anisotropic bond magnet using a thermosetting resin (for example, a heat resistant thermosetting resin having high viscosity) that has been difficult to be used as a raw material of the conventional anisotropic bond magnet. For example, the heat resistant thermosetting resin may be at least one resin selected from the group consisting of an epoxy resin, a maleimide compound, polyimide, polyamide, and polyamideimide. Details of the thermosetting resin will be described later.

As described above, the residual magnetic flux density of the anisotropic bond magnet increases due to the wax. However, unlike the thermosetting resin (binder), the wax is not cured and does not bind the magnetic particles to each other. Therefore, the mechanical strength of the compact 2A decreases due to the wax remaining in the compact 2A. Since the wax derived from the compound 2 remains in the magnetic compact obtained from the compact 2A, the mechanical strength of the magnetic compact also decreases. Since the wax derived from the compound 2 remains in the anisotropic bond magnet obtained from the magnetic compact, the mechanical strength of the anisotropic bond magnet also decreases. However, in the molding step, the compound 2 is compressed while the mold is heated at the molding temperature Tm equal to or higher than the dropping point of the wax. As a result, in the process of forming the compact 2A (the process of compressing the compound 2), a part or all of the liquefied wax in the compact 2A bleeds from the compact 2A, and the wax is removed from the compact 2A. Therefore, according to the present embodiment, it is possible to suppress a decrease in the mechanical strength of the anisotropic bond magnet caused by the wax that contributes to an increase in the residual magnetic flux density of the anisotropic bond magnet. That is, according to the present embodiment, it is possible to achieve both a high residual magnetic flux density and a high mechanical strength.

In the molding step, the wax 4 removed from the compact 2A is discharged to the outside of the mold through the clearance 6 formed in the mold (see (b) in FIG. 1). The molding temperature Tm is equal to or higher than the dropping point of the wax and lower than the thermal curing temperature of the thermosetting resin. Therefore, the viscosity of the wax at the molding temperature Tm is lower than the viscosity of the thermosetting resin at the molding temperature Tm, the wax is more likely to flow than the thermosetting resin at the molding temperature Tm, and the wax and the thermosetting resin are less likely to be compatible at the molding temperature Tm. As a result, the wax 4 is easily separated from the thermosetting resin in the molding step, only the wax 4 among the wax 4 and the thermosetting resin is selectively removed from the compact 2A, and only the wax 4 is easily discharged to the outside of the mold through the clearance 6. In contrast, the thermosetting resin is difficult to be removed from the compact 2A in the molding step, and the thermosetting resin is difficult to be discharged to the outside of the mold through the clearance 6.

The dropping point of the wax is a temperature at which the wax is liquefied by heating. For example, the dropping point of the wax is the temperature of the wax at the time when the wax in a container, where an opening portion having a predetermined inner diameter is formed, is liquefied by heating and the liquefied wax starts to drop from the opening. For example, the dropping point of the wax may be measured based on Japanese Industrial Standard (JIS) K 2220 or D-566 and D-2265 of America Society for Testing and Materials (ASTM) standard.

The dropping point of the wax is a value depending on a composition of the wax, and is not limited. The thermal curing temperature of the thermosetting resin is a value depending on a composition of the thermosetting resin, and is not limited. The molding temperature Tm is a value depending on the combination of the wax and the thermosetting resin, and is not limited. For example, the molding temperature Tm may be 60° C. or higher and 150° C. or lower, preferably 70° C. or higher and 110° C. or lower, and more preferably 80° C. or higher and 100° C. or lower.

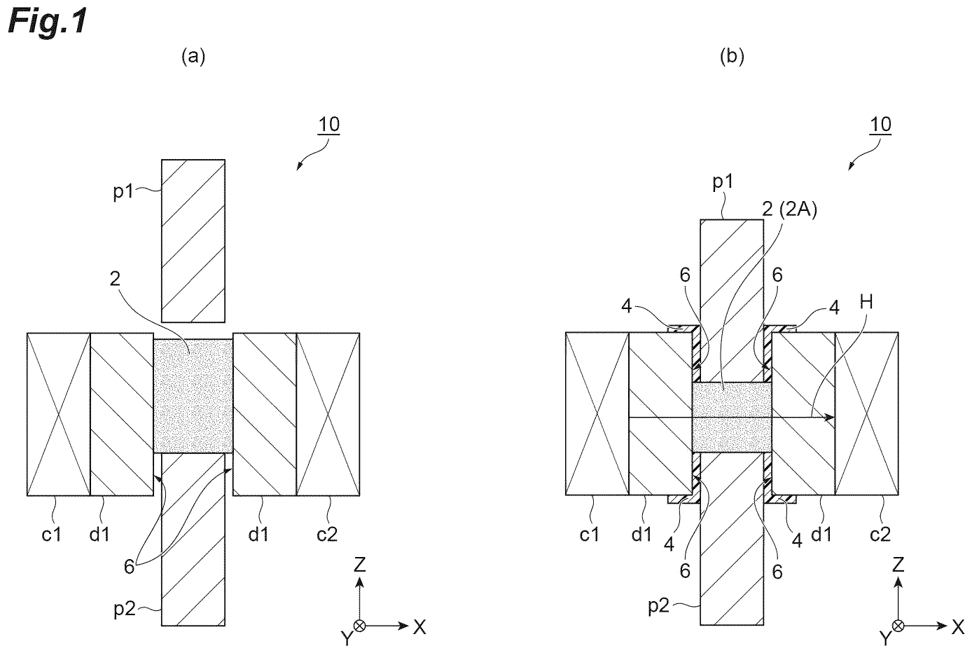

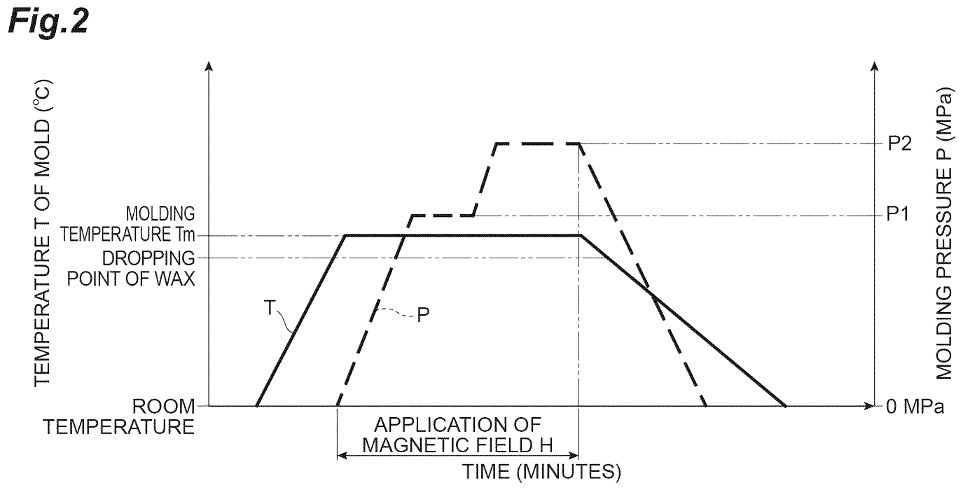

The molding step may include a first pressurizing step and a second pressurizing step subsequent to the first pressurizing step. As illustrated in FIG. 2, in the first pressurizing step, a pressure (molding pressure P) acting on the compound in the mold heated at the molding temperature Tm continuously increases from 0 MPa to a first pressure P1 (unit: MPa), and is maintained at the first pressure P1 for a predetermined time. As illustrated in FIG. 2, in the second pressurizing step, a pressure (molding pressure P) acting on the compound in the mold heated at the molding temperature Tm continuously increases from the first pressure P1 to a second pressure P2 (unit: MPa), and is maintained at the second pressure P2 for a predetermined time. That is, the second pressure P2 is higher than the first pressure P1. In the first pressurizing step, the compound is pressurized at the relatively low first pressure P1, so that excessive compression of the compound is suppressed, friction or contact between the magnetic particles is suppressed, each magnetic particle in the compound easily rotates, and each magnetic particle is easily oriented along the magnetic field. In the second pressurizing step, the compact (compound) is pressurized at a relatively high second pressure P2, so that the wax is easily removed from the compact.

For example, the first pressure P1 may be more than 0 MPa and less than 500 MPa. For example, the second pressure P2 may be 500 MPa or more and 2000 MPa or less, preferably 700 MPa or more and 2000 MPa or less, and more preferably 980 MPa or more and 2000 MPa or less. As the first pressure P1 is lower, excessive compression of the compound is easily suppressed, each magnetic particle in the compound easily rotates, and the magnetization direction of each magnetic particle is easily oriented substantially parallel to the magnetic field. As the second pressure P2 is higher, the compact (compound) is easily compressed, and the wax is easily removed from the compact.

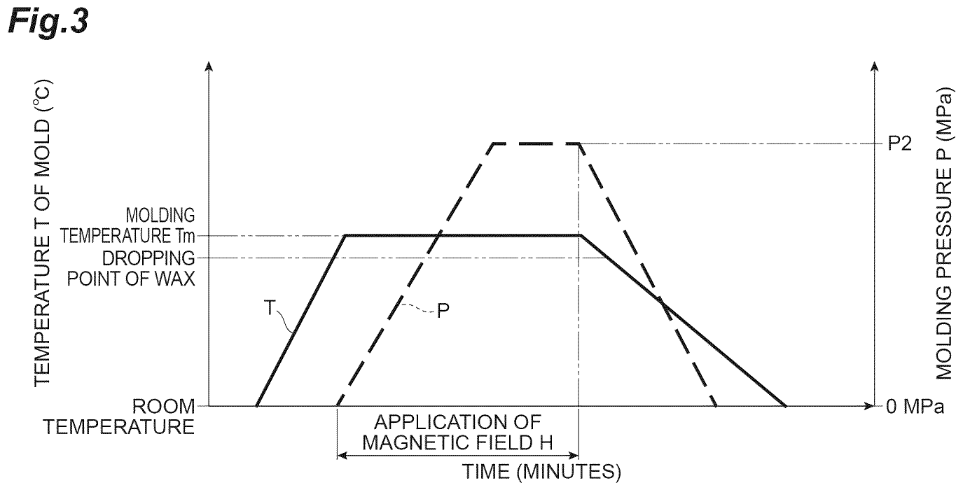

As illustrated in FIG. 3, in the molding step, the wax is removed from the compact by continuously increasing the pressure (molding pressure P) acting on the compound in the mold heated at the molding temperature Tm from 0 MPa to the second pressure P2. Also in the molding step illustrated in FIG. 3, the molding pressure P may be maintained at the second pressure P2 for a predetermined time.

The total of the mass of the magnetic powder and the mass of the thermosetting resin is represented by M1 (unit: g). The mass of the wax in the compound is represented by M2 (unit: g). (M2/M1)×100 may be 2 or more and 10 or less, 2.5 or more and 8 or less, 2 or more and 5 or less, or 2.0 or more and 4.0 or less. In a case where (M2/M1)×100 is 2 or more, each magnetic particle 3 easily rotates, and each magnetic particle 3 is easily oriented along the magnetic field H due to the lubricity of the wax 4. In a case where (M2/M1)×100 is 10 or less, most of the wax is easily removed from the compact during the molding step, the wax is difficult to remain in the anisotropic bond magnet, and the anisotropic bond magnet is likely to have a high mechanical strength. For example, in a case where a magnetic compact and an anisotropic bond magnet are manufactured from the compound in which (M2/M1)×100 is 2 or more and 10 or less, the content of the wax in the magnetic compact may be 0.0% by mass or more and 0.1% by mass or less, and the content of the wax in the anisotropic bond magnet may also be 0.0% by mass or more and 0.1% by mass or less.

A mass M3 of the wax in the compact (magnetic compact) that has been subjected to the molding step is smaller than a mass M2 of the wax in the compound, and the mass of the wax removed from the compact (compound) through the molding step is M2−M3. On the other hand, in the molding step, the total mass M1 of the magnetic powder and the thermosetting resin in the compound (compact) remains almost unchanged. Therefore, M2−M3 is substantially equal to the difference between the mass of the compound supplied into the mold and the mass of the compact after the molding step. That is, the content of the wax in the magnetic compact (or in the anisotropic bond magnet) can be calculated based on the difference between the mass of the compound supplied into the mold and the mass of the compact after the molding step.

In the molding step, the application of the magnetic field to the compound in the mold may be started after the time point when the temperature of the heated mold reaches the molding temperature Tm. As a result, due to the lubricity of the liquefied wax, the magnetic particles easily slide against one another, each magnetic particle easily rotates, and each magnetic particle is easily oriented along the magnetic field.

In the molding step, the application of the magnetic field to the compound in the mold may be started at the same time as the compression of the compound in the mold. The application of the magnetic field to the compound in the mold may be started earlier than the compression of the compound in the mold. In a case where the application of the magnetic field to the compound in the mold is started earlier than the compression of the compound in the mold, each magnetic particle in the compound easily rotates in a state in which the compression of the compound is suppressed. As a result, each magnetic particle is easily oriented along the magnetic field. In the molding step, the application of the magnetic field to the compound in the mold may be stopped at the time point when the molding pressure P starts to decrease. That is, the application of the magnetic field to the compound in the mold may be stopped at the same time as the end of the second pressurizing step. The application of the magnetic field to the compound in the mold may also be stopped at the same time as the start of the second pressurizing step. That is, the application of the magnetic field to the compound in the mold may be stopped at the time point when the molding pressure reaches the second pressure P2.

The magnetic field H may be a static magnetic field (continuous constant magnetic field). The magnetic field H may be a pulsed magnetic field (pulse-type magnetic field). As the intensity of the magnetic field H is higher, the orientation of the magnetic powder in the compact is improved. As the time for applying the magnetic field H to the compound in the mold is longer, the orientation of the magnetic powder in the compact is improved. As the number of times of applying the magnetic field H to the compound in the mold is increased, the orientation of the magnetic powder in the compact is improved.

The intensity of the static magnetic field used for manufacturing the anisotropic bond magnet is lower than the intensity of the pulsed magnetic field. In a case where the magnetic field H is a static magnetic field, the magnetic field H is applied to the compound in the mold for a sufficiently long period of time to sufficiently orient each magnetic particle in the compound along the magnetic field. For example, the intensity of the static magnetic field may be 0.5 T (Tesla) or more and 2.5 T or less, preferably 1.0 T or more and 2.5 T or less, and more preferably 2.0 T or more and 2.5 T or less. For example, the time for applying the static magnetic field to the compound in the mold may be 0.08 minutes or more and 4 minutes or less, preferably 0.5 minutes or more and 4 minutes or less, and more preferably 1 minute or more and 4 minutes or less.

The pulsed magnetic field used for manufacturing the anisotropic bond magnet has a higher intensity than that of the static magnetic field. Since the pulsed magnetic field is instantaneously generated, the amount of heat (Joule heating in the coil) generated by a current required to generate the pulsed magnetic field can be reduced. The instantaneous application of a high-intensity pulsed magnetic field to the compound in the mold causes each magnetic particle in the compound to be oriented instantaneously and sufficiently along the magnetic field. From the viewpoint of the limit and cost of the intensity of the pulsed magnetic field that can be generated by a commercially available pulse-type magnetic field generator, the upper limit value of the intensity of the pulsed magnetic field is about 12 T. For example, the intensity of the pulsed magnetic field may be 4 T or more and 12 T or less, or 8 T or more and 12 T or less. The number of times the pulsed magnetic field is applied to the compound may be one or more. For example, a pulsed magnetic field with an intensity of 4 T or more may be applied to the compound one or more times.

### <Cooling Step>

As described above, the manufacturing method for a magnetic compact may further include a cooling step. The cooling step is subsequent to the molding step described above. The demagnetizing step may be performed after the cooling step. In the cooling step, the mold in which the compact is contained is cooled from the molding temperature Tm to a temperature (for example, room temperature) lower than the dropping point of the wax. In the cooling step, the magnetic field H does not need to be applied to the compact in the mold. However, the magnetic field H may be applied to the compact in the mold in the cooling step.

The thermosetting resin (uncured product) in the compact is softened by heating the mold during the molding step. The softened thermosetting resin in the compact is solidified by the cooling step. In a case where the wax remains during molding, the liquefied wax in the compact is solidified by the cooling step. For these reasons, the mechanical strength of the compact is increased during the cooling step, and deformation and breakage of the compact in each step after the cooling step are suppressed. As a result, the mechanical strength of the finally obtained anisotropic bond magnet is likely to increase. In a case where the demagnetizing step is performed before the thermosetting resin (uncured product) and the wax in the compact are sufficiently solidified, the position and orientation direction of each magnetic particle in the compact are likely to change with the application of the magnetic field to the compact in the demagnetizing step, and the orientation of the magnetic powder in the compact may be impaired. That is, in a case where the demagnetizing step is performed subsequent to the molding step without performing the cooling step, the orientation of the magnetic powder in the compact may be impaired in the demagnetizing step.

For example, the method for cooling the mold in which the compact is contained may be natural cooling of the mold. As illustrated in FIG. 2 and FIG. 3, the molding pressure P may gradually decrease from the second pressure P2 to 0 MPa in the cooling step (the process in which the temperature T of the mold decreases to room temperature). The molding pressure P may be instantaneously released at the start of the cooling step (at the end of the molding step). That is, at the start of the cooling step (at the end of the molding step), the molding pressure P may instantaneously decrease from the second pressure P2 to 0 MPa.

### <Demagnetizing Step>

The demagnetizing step is performed after the molding step. In the demagnetizing step, the compact is demagnetized by applying a magnetic field (reversed magnetic field) in a direction opposite to the magnetic field H used in the molding step to the compact. For the reasons described above, the demagnetizing step may be performed after the cooling step subsequent to the molding step. The demagnetizing step may also be performed at the same time as the cooling step. That is, the compact may be demagnetized by applying a reversed magnetic field to the compact contained in the mold in parallel with the cooling of the mold. After the compact is demagnetized at the same time as the cooling step, the compact is taken out of the mold. The demagnetizing step may be performed by the manufacturing apparatus 10 (molding apparatus) used in the molding step. After the cooling step, the compact taken out of the mold may be demagnetized by another magnetic field application apparatus.

### <Thermal Curing Step>

The thermal curing step is performed after the demagnetizing step. In the thermal curing step, the compact is heated at a temperature equal to or higher than the thermal curing temperature of the thermosetting resin. As a result, the thermosetting resin in the compact is cured, and a magnetic compact is obtained from the compact. The magnetic powder in the magnetic compact is bound together by a cured product of the thermosetting resin, and each magnetic particle is fixed in the magnetic compact. In the thermal curing step, a plurality of compacts that have been subjected to the demagnetizing step may be collectively heated.

In the thermal curing step, the temperature of the compact increases from room temperature to a temperature equal to or higher than the thermal curing temperature of the thermosetting resin. At the time point before the temperature of the compact reaches the thermal curing temperature in the thermal curing step, the thermosetting resin (and wax) in the compact is softened, resulting in softening the compact itself. The position and direction of each magnetic particle in the softened compact are not sufficiently fixed due to the softened thermosetting resin. In a case where the thermal curing step is performed without performing the demagnetizing step, the position and direction of each magnetic particle in the softened compact change due to the magnetic force of the compact itself, and the orientation of the magnetic powder in the compact is impaired. As a result, it is difficult for the anisotropic bond magnet to have a high residual magnetic flux density. For example, each magnetic particle positioned near a surface of the softened compact protrudes from the surface of the compact together with the thermosetting resin (and wax). That is, one or more protrusions containing the magnetic particles and the thermosetting resin are formed on the surface of the compact. This is because the magnetic force is likely to act on the magnetic particles positioned near the surface of the compact in a portion having a high magnetic flux density in the surface of the compact not subjected to the demagnetizing step.

### <Magnetizing Step>

The magnetizing step is performed after the thermal curing step. In the magnetizing step, a magnetic field in the same direction as the magnetic field H used in the molding step is applied to the magnetic compact. As a result, the magnetic compact is magnetized to be an anisotropic bond magnet. As illustrated in FIG. 4, a magnetization direction M of the entire anisotropic bond magnet 2B is substantially parallel to the direction of the magnetic field H applied to the compound (compact) in the molding step. In other words, a magnetization direction m of each magnetic particle 3 in an anisotropic bond magnet 2B is substantially parallel to the magnetic field H.

### <Analysis Method>

In order to analyze and identify compositions of the magnetic compact and the anisotropic bond magnet, samples obtained by pulverizing each of the magnetic compact and the anisotropic bond magnet may be analyzed. In order to retroactively analyze and identify a composition of the compound itself, based on each of the magnetic compact and the anisotropic bond magnet, samples obtained by pulverizing each of the magnetic compact and the anisotropic bond magnet may also be analyzed. Furthermore, the sample obtained by pulverization may be dissolved in an organic solvent to separate the magnetic powder constituting the sample from a resin composition dissolved in the organic solvent. The resin composition and the magnetic powder separated from each other may be individually analyzed.

In a case where a composition of the uncured compound is analyzed and identified, the compound may be dissolved in an organic solvent to separate the magnetic powder from the resin composition dissolved in the organic solvent. The resin composition and the magnetic powder separated from each other may be individually analyzed.

For example, each component (thermosetting resin, wax, or the like) constituting the resin composition may be analyzed and identified by one or more analysis methods selected from the group consisting of an infrared spectroscopy (IR), a nuclear magnetic resonance (NMR), a mass spectrometry (MS), a gas chromatography (GC), and a high performance liquid chromatography (HPLC).

For example, the magnetic powder may be analyzed and identified by one or more analysis methods selected from the group consisting of an X-ray fluorescence (XRF), an inductively coupled plasma (ICP), an X-ray photoelectron spectroscopy (XPS), an energy dispersive X-ray spectroscopy (EDS or EDX), and a mass spectrometry.

A residual magnetic flux density Br1 of the magnetic compact (or the anisotropic bond magnet) and a residual magnetic flux density Br2 of the magnetic powder itself may satisfy the following Formula 1.

$$Br 1 = Br 2 \times ( V 2 / V 1 ) \times D \qquad ( Formula 1 )$$

V1 in Formula 1 is the entire volume of the magnetic compact (or the anisotropic bond magnet). V2 in Formula 1 is the volume of the magnetic powder itself contained in the magnetic compact (or the anisotropic bond magnet). V2/V1 corresponds to the filling rate of the magnetic powder in the magnetic compact (or the anisotropic bond magnet). D in Formula 1 is an orientation degree of the magnetic powder in the magnetic compact (or the anisotropic bond magnet). Based on the above Formula 1, the orientation degree D is represented by Br1/{Br2×(V2/V1)}. That is, the orientation degree D can be specified based on the measurement of each of Br1, Br2, V1, and V2. A high orientation degree means that the easy magnetization axis in each magnetic particle constituting the magnetic powder contained in the magnetic compact is oriented. In other words, the high orientation degree means that the magnetization direction of each magnetic particle constituting the magnetic powder contained in the anisotropic bond magnet is oriented. For example, the orientation degree D (unit: %) of the magnetic powder in the magnetic compact (or the anisotropic bond magnet) may be 80% or more and 100% or less.

### (Compound)

### <Magnetic Powder>

As described above, the magnetic powder includes a powder containing a Sm—Fe—N based permanent magnet (SmFeN powder). For example, the SmFeN powder may be a powder containing Sm₂Fe₁₇N₃ (alloy) as a main phase. For example, at least a part of the SmFeN powder may be an anisotropic magnetic powder containing a Th₂Zn-type crystal (rhombohedral crystal) as a main phase. The anisotropic magnetic powder is a magnetic powder in which individual magnetic particles constituting the magnetic powder are single crystals, or a magnetic powder in which individual magnetic particle constituting the magnetic powder is composed of a large number of fine single crystal grains (magnetic domains), and the direction of the easy magnetization axis of the individual crystal grain is aligned in a specific direction. For example, at least a part of the SmFeN powder may be an isotropic magnetic powder containing a TbCu₇-type crystal (hexagonal crystal) as a main phase. The isotropic magnetic powder is a magnetic powder in which individual magnetic particle constituting the magnetic powder is a large number of fine single crystal grains (magnetic domains), and the direction of the easy magnetization axis of the individual crystal grain is random.

A manufacturing method for the SmFeN powder is not limited. For example, the manufacturing method for the SmFeN powder may include a step of forming an alloy powder containing Sm and Fe by a mechanical alloying method, and a step of heating the alloy powder in a nitrogen gas to obtain a SmFeN powder. The SmFeN powder may be manufactured by a rapid-cooling solidification method. In the rapid-cooling solidification method, a molten alloy is supplied to a surface of a water-cooling roll that is rotating. As a result, the molten alloy is rapidly cooled and solidified on the surface of the water-cooling roll. The solidified alloy is pulverized to obtain a SmFeN powder. In addition, the SmFeN powder may be manufactured by a hydrogenation disproportionation desorption recombination (HDDR) method.

As the SmFeN powder, for example, a non-pulverized powder (spherical magnetic powder) obtained by a build-up method made by NICHIA CORPORATION may be used. The surface of each magnetic particle constituting the SmFeN powder may be covered with an inorganic film by surface treatment of each magnetic particle. For example, the inorganic film may contain a phosphate or a silica-based compound.

The average particle size d₅₀ of the SmFeN powder may preferably be 0.5 μm or more and 100 μm or less, more preferably 1 μm or more and 10 μm or less, and still more preferably 2 μm or more and 3 μm or less. The average particle size of the SmFeN powder can be measured by a laser diffraction particle size distribution analyzer.

### <Wax>

For example, the wax may be at least one composition selected from the group consisting of synthetic wax, saturated fatty acid, saturated fatty acid salt, and saturated fatty acid ester. For example, the wax may be at least one wax selected from the group consisting of polyethylene wax, amide wax, and montan wax. As a commercially available product of the polyethylene wax, at least one selected from the group consisting of Licolub H12, Licowax PE520, and Licowax PED191 (all of which are trade names, manufactured by Clariant Plastics & Coatings (Japan) K.K) may be used. As a commercially available product of the amide wax, at least one of Licolub FA1 (trade name, manufactured by Clariant Plastics & Coatings (Japan) K.K) and DISPARLON6650 (trade name, manufactured by Kusumoto Chemicals, Ltd.) may be used. As a commercially available product of the montan wax, at least one selected from the group consisting of Licowax E, Licowax OP, Licolub E, and Licolub WE40 (all of which are trade names, manufactured by Clariant Plastics & Coatings (Japan) K.K) may also be used. Each of the Licowax E, the Licowax OP, the Licolub E, and the Licolub WE40 is a montanic acid ester.

The wax may be appropriately selected according to requirements for the design of the compound, such as the orientation of the magnetic powder in the molding step, the releasability of the compact, the molding temperature and molding pressure, and the melting point, dropping point and melt viscosity of the wax. Among the waxes described above, the montan wax (montanic acid ester) is preferable, and Licowax E is particularly preferable, from the viewpoint of easily improving the orientation of the magnetic powder in the molding step. The dropping point of Lycowax E (montanic acid ester) is 82° C., and the melt viscosity of Lycowax E (montanic acid ester) at 100° C. is 30 mPa·s.

The compound may contain one wax among those described above. The compound may contain a plurality of waxes among those described above.

### <Resin Composition>

In the present embodiment, the “resin composition” means the remaining part (nonvolatile component) of the compound excluding the magnetic powder and the wax. The resin composition contains at least a thermosetting resin. The resin composition may further contain at least one component selected from the group consisting of a curing agent, a curing accelerator, a coupling agent, a flame retardant, and a flow aid. The compound itself may include an organic solvent.

The resin composition has a function as a binding material (binder) that binds a plurality of magnetic particles constituting the magnetic powder to one another. That is, the resin composition imparts mechanical strength to the anisotropic bond magnet manufactured from the compound. For example, in the molding step, filling the resin composition is performed between the plurality of magnetic particles to bind the magnetic particles to one another. By thermal curing of the resin composition, the cured product of the resin composition more firmly binds the magnetic particles to one another.

For example, the thermosetting resin contained in the resin composition may be at least one resin selected from the group consisting of an epoxy resin, a phenolic resin (including a phenol novolac resin), a maleimide compound, polyimide, polyamide, and polyamideimide. In a case where the compound contains both an epoxy resin and a phenolic resin, the phenolic resin may function as a curing agent for the epoxy resin. The thermosetting resin in the compound may be at least one of an uncured resin or a semi-cured resin.

The mass of the magnetic powder in the compound is represented by Mm (unit: g), and the total mass of the resin composition in the compound is represented by Mr (unit: g). The occupancy factor is defined as M/(Mm+Mr)×100. The occupancy factor may be 90.0 or more and 99.9 or less, preferably 95.0 or more and 99.5 or less, and more preferably 96.0 or more and 98.0 or less. In a case where the occupancy factor is 90.0 or more, the anisotropic bond magnet is likely to have a sufficiently high residual magnetic flux density. In a case where the occupancy factor is 99.9 or less, the anisotropic bond magnet is likely to have a sufficiently high mechanical strength.

### <Epoxy Resin>

Any epoxy resin can be used as long as it is an epoxy resin having two or more epoxy groups in one molecule. From the viewpoint of improving heat resistance (mechanical strength at high temperature) of the anisotropic bond magnet, a heat-resistant epoxy resin such as a naphthalene-type epoxy resin is preferable.

For example, the epoxy resin may be at least one selected from the group consisting of a biphenyl-type epoxy resin, a stilbene-type epoxy resin, a diphenylmethane-type epoxy resin, a sulfur atom-containing epoxy resin, a novolac-type epoxy resin, a dicyclopentadiene-type epoxy resin, a salicylaldehyde-type epoxy resin, a copolymer-type epoxy resin of naphthols and phenols, an epoxidized aralkyl-type phenolic resin, a bisphenol-type epoxy resin, a glycidyl ether-type epoxy resin of alcohols, a glycidyl ether-type epoxy resin of para-xylylene-modified phenolic resin and/or meta-xylylene-modified phenolic resin, a glycidyl ether-type epoxy resin of terpene-modified phenolic resin, a cyclopentadiene-type epoxy resin, a glycidyl ether-type epoxy resin of polycyclic aromatic ring-modified phenolic resin, a glycidyl ether-type epoxy resin of naphthalene ring-containing phenolic resin, a glycidyl ester-type epoxy resin, a glycidyl or methylglycidyl-type epoxy resin, an alicyclic-type epoxy resin, a halogenated phenol-novolac-type epoxy resin, an ortho-cresol novolac-type epoxy resin, a hydroquinone-type epoxy resin, a trimethylolpropane-type epoxy resin, and a linear aliphatic epoxy resin obtained by oxidizing an olefinic bond with a peracid such as peracetic acid. As the epoxy resin having a high crystallinity, a hydroquinone epoxy resin, a bisphenol-type epoxy resin, a thioether-type epoxy resin, a biphenyl-type epoxy resin, or the like may be used.

At least a part of the epoxy resin may be a naphthalene-type epoxy resin having a naphthalene structure. The naphthalene-type epoxy resin is solid at normal temperature. In a case where the compound contains a naphthalene-type epoxy resin, the anisotropic bond magnet is likely to have a high mechanical strength at room temperature and a high temperature. For example, the naphthalene-type epoxy resin may be at least one epoxy resin selected from the group consisting of a naphthalene diepoxy compound, a naphthylene ether-type epoxy resin, a naphthalene novolac-type epoxy resin, a methylene-linked dimer of a naphthalene diepoxy compound, and a methylene conjugate of a naphthalene monoepoxy compound and a naphthalene diepoxy compound.

The naphthalene-type epoxy resin is preferably at least one of a trifunctional epoxy resin or a tetrafunctional epoxy resin. The naphthalene-type epoxy resin is more preferably a tetrafunctional epoxy resin. In a case where the naphthalene-type epoxy resin contained in the compound is at least one of a trifunctional epoxy resin or a tetrafunctional epoxy resin, naphthalene-type epoxy resins are three-dimensionally crosslinked with each other during the thermal curing step to form a strong crosslinked network. As a result, the movement of the naphthalene-type epoxy resins in the anisotropic bond magnet is easily suppressed at a high temperature. That is, the glass transition temperature of each of the trifunctional epoxy resin and the tetrafunctional epoxy resin is higher than the glass transition temperature of the bifunctional epoxy resin. Therefore, in a case where the naphthalene-type epoxy resin contained in the compound is at least one of a trifunctional epoxy resin or a tetrafunctional epoxy resin, the anisotropic bond magnet is likely to have a high mechanical strength at a high temperature.

For example, as the trifunctional naphthalene-type epoxy resin or the tetrafunctional naphthalene-type epoxy resin, a commercially available product such as HP-4700, HP-4710, HP-4770, EXA-5740, or EXA-7311-G4 manufactured by DIC Corporation may be used. The naphthalene-type epoxy resin contained in the compound may be a bifunctional epoxy resin. As the bifunctional naphthalene-type epoxy resin, a commercially available product such as HP-4032 or HP-4032D may be used. The naphthalene-type epoxy resin contained in the compound powder may be a β-naphthol-type epoxy resin.

The compound may contain one epoxy resin among those described above. The compound may contain a plurality of epoxy resins among those described above.

### <Curing Agent/Phenolic Resin>

The curing agent is classified into a curing agent for curing an epoxy resin in a range from a low temperature to room temperature and a heat curing-type agent for curing an epoxy resin with heating. Examples of the curing agent for curing an epoxy resin in a range from a low temperature to room temperature include aliphatic polyamines, polyaminoamides, and polymercaptans. Examples of the heat curing-type agent include aromatic polyamines, acid anhydrides, phenol novolac resins, and dicyandiamides (DICY).

In a case where the curing agent for curing an epoxy resin in a range from a low temperature to room temperature is used, the glass transition point of an epoxy resin cured product decreases, and the epoxy resin cured product is likely to be soft. As a result, the anisotropic bond magnet manufactured from the compound is also likely to be soft. Therefore, from the viewpoint of improving the heat resistance of the anisotropic bond magnet, the curing agent may preferably be a heat curing-type agent, more preferably a phenolic resin, and still more preferably a phenol novolac resin. In particular, by using a phenol novolac resin as a curing agent, an epoxy resin cured product having a high glass transition point is easily obtained. As a result, the heat resistance of the anisotropic bond magnet is easily improved.

For example, the phenolic resin may be at least one selected from the group consisting of an aralkyl-type phenolic resin, a dicyclopentadiene-type phenolic resin, a salicylaldehyde-type phenolic resin, a novolac-type phenolic resin, a copolymerization-type phenolic resin of a benzaldehyde-type phenol and an aralkyl-type phenol, a paraxylylene- and/or metaxylylene-modified phenolic resin, a melamine-modified phenolic resin, a terpene-modified phenolic resin, a dicyclopentadiene-type naphthol resin, a cyclopentadiene-modified phenolic resin, a polycyclic aromatic ring-modified phenolic resin, a biphenyl-type phenolic resin, and a triphenylmethane-type phenolic resin. The phenolic resin may be a copolymer of two or more phenolic resins among those described above.

The phenol novolac resin may be, for example, a resin obtained by condensation or co-condensation of phenols and/or naphthols with aldehydes under an acidic catalyst. The phenols constituting the phenol novolac resin may be, for example, at least one selected from the group consisting of phenol, cresol, xylenol, resorcin, catechol, bisphenol A, bisphenol F, phenylphenol, and aminophenol. The naphthols constituting the phenol novolac resin may be, for example, at least one selected from the group consisting of α-naphthol, β-naphthol, and dihydroxynaphthalene. The aldehydes constituting the phenol novolac resin may be, for example, at least one selected from the group consisting of formaldehyde, acetaldehyde, propionaldehyde, benzaldehyde, and salicylaldehyde.

The curing agent may be, for example, a compound having two phenolic hydroxyl groups in one molecule. The compound having two phenolic hydroxyl groups in one molecule may be, for example, at least one selected from the group consisting of resorcin, catechol, bisphenol A, bisphenol F, and substituted or unsubstituted biphenol.

Examples of commercially available phenolic resins include Tamanols 758 and 759 manufactured by Arakawa Chemical Industries, Ltd., and HP-850N manufactured by Showa Denko Materials Co., Ltd.

The compound may contain one phenolic resin among those described above. The compound may contain a plurality of phenolic resins among those described above.

The ratio of the hydroxyl equivalent of the phenolic resin to the epoxy equivalent of the epoxy resin may be 0.5 or more and 1.5 or less, 0.9 or more and 1.4 or less, 1.0 or more and 1.4 or less, or 1.0 or more and 1.2 or less. That is, the ratio of an active group (phenolic OH groups) in the phenolic resin reacting with an epoxy group in the epoxy resin may preferably be 0.5 equivalents or more and 1.5 equivalents or less, more preferably 0.9 equivalents or more and 1.4 equivalents or less, still more preferably 1.0 equivalents or more and 1.4 equivalents or less, and particularly preferably 1.0 equivalents or more and 1.2 equivalents or less, with respect to one equivalent of epoxy group in the epoxy resin. In a case where the ratio of the active group in the phenolic resin is less than 0.5 equivalents, the amount of OH per unit weight of the epoxy resin after curing is reduced, and the curing rate of the resin composition (epoxy resin) is reduced. In a case where the ratio of the active group in the phenolic resin is less than 0.5 equivalents, the glass transition temperature of the cured product to be obtained is likely to decrease, and it is difficult to obtain a sufficient elastic modulus of the cured product. On the other hand, in a case where the ratio of the active group in the phenolic resin is 1.5 equivalents or less, the anisotropic bond magnet is likely to have a high mechanical strength.

### <Maleimide Compound: Bismaleimide and Aminophenol Adduct>

The maleimide compound is at least one compound of bismaleimide and an aminophenol adduct of bismaleimide. The imide ring constituting bismaleimide is rigid. The phenyl ring constituting the aminophenol adduct of bismaleimide is also rigid. Due to these molecular structures, the maleimide compound has excellent heat resistance and is less likely to thermally expand as compared with conventional thermosetting resins (for example, epoxy resin). In particular, the crosslinking density of the aminophenol adduct is relatively high. Due to the above characteristics of the maleimide compound, the maleimide compound (in particular, aminophenol adduct) has excellent heat resistance and is less likely to thermally expand as compared with a conventional thermosetting resin (for example, epoxy resin). In other words, the maleimide compound (in particular, aminophenol adduct) is less likely to be softened and deformed at a high temperature. Thus, an anisotropic bond magnet manufactured from a compound containing the maleimide compound (in particular, aminophenol adduct) can have a high mechanical strength at a high temperatures (for example, 150° C.).

The bismaleimide (the following bismaleimides (a)) includes a compound (for example, monomer or polymer) containing a structural unit having two or more maleimide groups. The aminophenol adduct of bismaleimide is an addition reaction product (for example, addition polymer) of the bismaleimides (a) and the aminophenols (b). That is, an aminophenol adduct of bismaleimide is obtained by an addition reaction (for example, addition polymerization reaction) of the bismaleimides (a) and the aminophenols (b). For example, one molecule of the bismaleimides (a) may react with one or more molecules of the aminophenols (b) to synthesize one molecule of the aminophenol adduct. An epoxy compound (c) (epoxy resin) may be added to the maleimide compound (particularly aminophenol adduct). By thermal curing of the maleimide compound (particularly, aminophenol adduct) to which the epoxy compound (c) is added, the maleimide compound (particularly, aminophenol adduct) is modified with the epoxy compound (c) to form a complex network structure containing the maleimide compound (particularly, aminophenol adduct) and the epoxy compound (c). As a result, the glass transition temperature of the cured product formed from the maleimide compound (particularly, aminophenol adduct) and the epoxy compound (c) is likely to increase, and the mechanical strength of the anisotropic bond magnet at a high temperature is likely to increase.

The bismaleimides (a) are represented by the following Chemical Formula A.

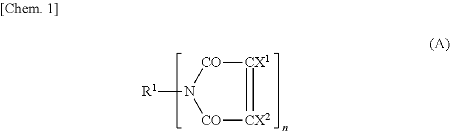

In the above Chemical Formula A, R¹ is an n-valent organic group. In the above Chemical Formula A, each of X¹ and X² each is a monovalent atom selected from hydrogen and halogen, or a monovalent organic group. X¹ and X² may be the same as each other, or X¹ and X² may be different from each other. In the above Chemical Formula A, n is an integer of 2 or more.

For example, the bismaleimides (a) include at least one compound selected from the group consisting of ethylene bismaleimide, hexamethylene bismaleimide, m-phenylene bismaleimide, p-phenylene bismaleimide, 2,2-bis[4-(4-maleimidophenoxy)phenyl]propane (also known as bisphenol bis(4-maleimidophenyl ether)), 4,4′-bismaleimidodiphenylmethane (also known as 4,4′-diphenylmethane bismaleimide), 4,4′-diphenyl ether bismaleimide, 4,4′-diphenyl sulfone bismaleimide, 4,4′-dicyclohexylmethane bismaleimide, m-xylylene bismaleimide, p-xylylene bismaleimide, and 4,4′-phenylene bismaleimide. The compound powder may further contain monomaleimides as necessary. The monomaleimides may be, for example, N-3-chlorophenylmaleimide or N-4-nitrophenylmaleimide.

The aminophenols (b) constituting the aminophenol adduct of bismaleimide is represented by the following Chemical Formula B.

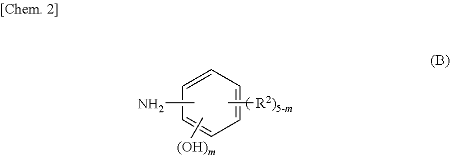

In Chemical Formula B, R² is a monovalent atom selected from hydrogen and halogen, or a monovalent organic group. In Chemical Formula B, m is an integer of 1 or more and 5 or less.

An aminophenol adduct represented by the following Chemical Formula C may be synthesized from the bismaleimides (a) represented by the above Chemical Formula A and the aminophenols (b) represented by the above Chemical Formula B.

In the following Chemical Formula C, α is an integer of 1 or more and n or less.

In the following Chemical Formula C, R¹ is an n-valent organic group. In the following Chemical Formula C, each of X¹ and X² is a monovalent atom selected from hydrogen and halogen, or a monovalent organic group. X¹ and X² may be the same as each other, or X¹ and X² may be different from each other. In the following Chemical Formula C, n is an integer of 2 or more.

In the following Chemical Formula C, R² is a monovalent atom selected from hydrogen and halogen, or a monovalent organic group. In the following Chemical Formula C, m is an integer of 1 or more and 5 or less.

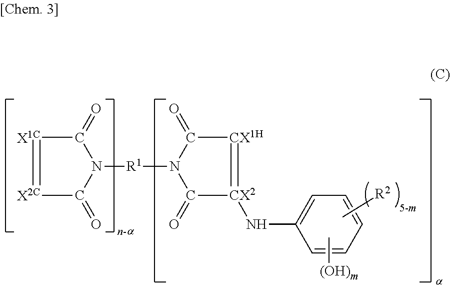

For example, the aminophenols (b) may be at least one compound selected from the group consisting of o-aminophenol, m-aminophenol, p-aminophenol, o-aminocresol, m-aminocresol, p-aminocresol, aminoxylenol, aminochlorphenol, aminobromphenol, aminocatechol, aminoresorcin, aminobis(hydroxyphenol)propane, and aminooxybenzoic acid.

The compound powder may further contain a compound other than the aminophenols (b) as a comonomer polymerizable with the bismaleimides (a). For example, the compound powder may further contain, as a comonomer polymerizable with the bismaleimides (a), at least one compound selected from the group consisting of aromatic amines other than the aminophenols (b), vinyl compounds, allyl compounds, allylphenols, and isocyanates.

The epoxy compound (c) added to the maleimide compound may have two or more epoxy groups in the molecule. For example, the epoxy compound (c) may be at least one compound selected from the group consisting of a bisphenol A-type epoxy resin, a bisphenol F-type epoxy resin, a novolac-type epoxy resin, a glycidyl ester resin of polycarboxylic acid, a polyglycidyl ether of polyol, a urethane-modified epoxy resin, a fatty acid-type polyepoxide obtained by epoxidizing an unsaturated compound, an alicyclic polyepoxide obtained by epoxidizing an unsaturated compound, an epoxy resin having a heterocyclic ring, an epoxy resin having a heterocyclic ring, and an epoxy resin obtained by glycidylating an amine.

The ratio of the mass of the aminophenols (b) may be 0 to 40 parts by mass, 5 to 40 parts by mass, and preferably 10 to 30 parts by mass, with respect to 100 parts by mass of the bismaleimides (a). In a case where the ratio of the mass of the aminophenols (b) is 5 parts by mass or more, the addition reaction product and the epoxy compound (c) are sufficiently compatible. In a case where the ratio of the mass of the aminophenols (b) is 40 parts by mass or less, the number of amino groups in the aminophenol adduct is moderately reduced, and the aminophenol adduct is likely to have excellent heat resistance. The reaction temperature of the bismaleimides (a) and the aminophenols (b) may be, for example, 50° C. to 200° C. and preferably 80° C. to 180° C. The reaction time of the bismaleimides (a) and the aminophenols (b) may be appropriately adjusted within a range of several minutes to several tens of hours.

The ratio of the maleimide compound with respect to the entire thermosetting resin contained in the compound powder may be, for example, 30% to 100% by mass or 30% to 80% by mass.

As the resin composition including the aminophenol adduct of bismaleimide, at least one commercially available product selected from KIR-3, KIR-30, KIR-50, and KIR-100 (all of which are trade names, manufactured by KYOCERA Corporation) may be used. KIR-3 is an example of the aminophenol adduct including no epoxy compound (c) (epoxy resin). KIR-30 is an example of the aminophenol adduct to which the epoxy compound (c) (epoxy resin) is added.

For example, KIR-3 and KIR-30 contain 4,4′-diphenylmethane bismaleimide represented by the following Chemical Formula 1 as bismaleimide.

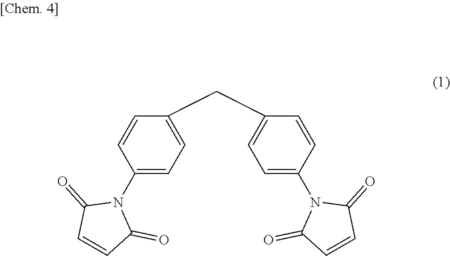 [SMILES: O=C1C=CC(=O)N1c1ccc(Cc2ccc(N3C(=O)C=CC3=O)cc2)cc1]

For example, KIR-3 and KIR-30 contain m-aminophenol represented by the following Chemical Formula 2.

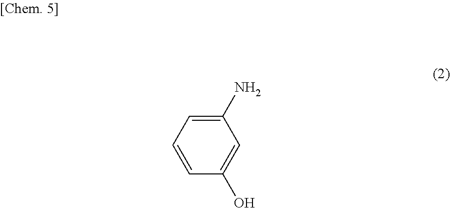

For example, the KIR-30 contains a bisphenol A-type epoxy resin represented by the following Chemical Formula 3 as an epoxy compound (epoxy resin). In the following Chemical Formula 3, n is an integer of 0 or more.

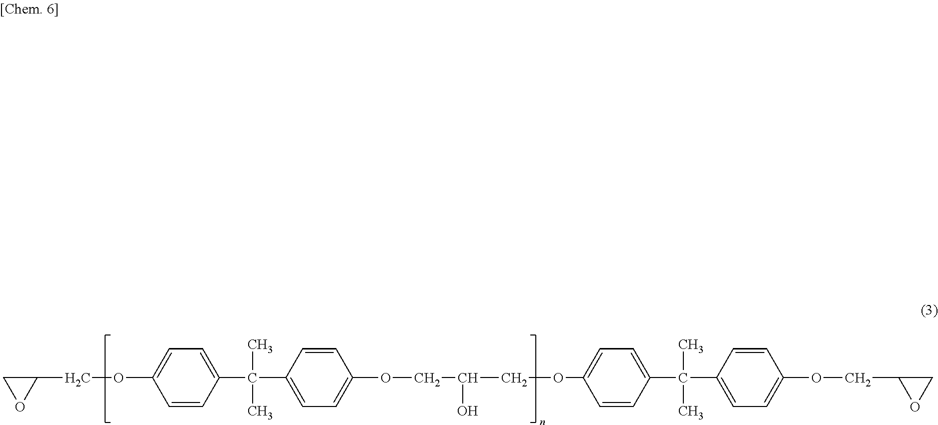

For example, KIR-3 and KIR-30 contain an aminophenol-1 adduct represented by the following Chemical Formula 4. The aminophenol-1 adduct is synthesized by an addition reaction of one molecule of 4,4′-diphenylmethane bismaleimide and one molecule of m-aminophenol.

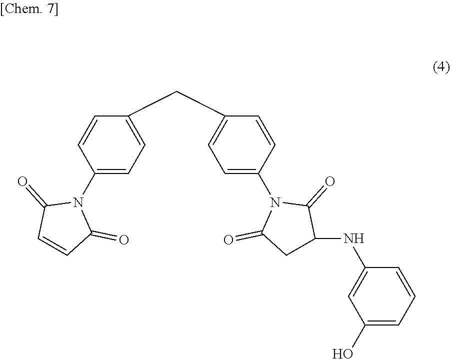 [SMILES: O=C1C=CC(=O)N1c1ccc(Cc2ccc(N3C(=O)CC(Nc4cccc(O)c4)C3=O)cc2)cc1]

For example, KIR-3 and KIR-30 contain an aminophenol-2 adduct represented by the following Chemical Formula 5. The aminophenol-2 adduct may be synthesized by an addition reaction of one molecule of 4,4′-diphenylmethane bismaleimide and two molecules of m-aminophenol. The aminopheno-2 adduct may be synthesized by an addition reaction of one molecule of the aminophenol 1-adduct and one molecule of m-aminophenol.

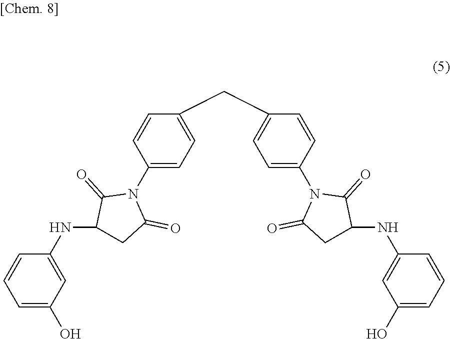 [SMILES: O=C1CC(Nc2cccc(O)c2)C(=O)N1c1ccc(Cc2ccc(N3C(=O)CC(Nc4cccc(O)c4)C3=O)cc2)cc1]

### <Polyimide>

For example, the polyimide may be a dehydrated polycondensate of tetracarboxylic anhydride and 4,4′-bis(3-aminophenoxy) biphenyl. The polyimide may be at least one resin selected from AURUM PL450C, AURUM PL500A, AURUM PL6200, and AURUM PD450L (all of which are products manufactured by Mitsui Chemicals, Inc.), SolverPI-5600 (a product manufactured by SOLVER POLYIMIDE), and SURPRIM (a product manufactured by MITSUBISHI GAS CHEMICAL COMPANY, INC.).

### <Polyamide>

For example, the polyamide may be at least one of particles of nylon 6 obtained from ε caprolactam and particles of nylon 12 obtained from lauryl lactam. For example, the polyamide may be at least one resin selected from the group consisting of nylon 6 particles (TR-1 and TR-2 manufactured by Toray Industries, Inc.) and nylon 12 particles (SP-500 and SP-10 manufactured by Toray Industries, Inc.).

### <Polyamideimide>

For example, the polyamideimide may be a polyamideimide having a siloxane structure. The polyamideimide may have two or more carboxy groups at at least one of both terminals of the molecular chain of the polyamideimide. The polyamideimide may be a polyamideimide described in Japanese Unexamined Patent Publication No. 2019-48948.

### <Other Resins>

The resin composition may contain the plurality of types of thermosetting resins described above. The resin composition may further contain another resin in addition to the above thermosetting resin. For example, as long as the mechanical strength of the anisotropic bond magnet is not impaired, the resin composition may contain a thermoplastic resin in addition to the thermosetting resin. For example, the resin composition may further contain at least one other resin selected from the group consisting of a polyphenylene sulfide resin, an acrylic resin, a methacrylic resin, polyethylene, polypropylene, polystyrene, polyvinyl chloride, polyethylene terephthalate, and a silicone resin.

### <Curing Accelerator>

For example, the curing accelerator may contain imidazoles. For example, an imidazole-based curing accelerator may be at least one compound selected from 1-cyanoethyl-2-undecylimidazole, 2-undecylimidazole, 2-heptadecylimidazole, 2-ethyl-4-methylimidazole, and 1-cyanoethyl-2-phenylimidazole. Examples of commercially available products of the imidazole-based curing accelerator include 2MZ-H, C11Z, C17Z, 1,2DMZ, 2E4MZ, 2PZPW, 2P4MZ, 1B2MZ, 1B2PZ, 2MZ-CN, C11Z-CN, 2E4MZ-CN, 2PZ-CN, C11Z-CNS, 2P4MHZ, TPZ, and SFZ (all of which are trade names, manufactured by Shikoku Chemicals Corporation). Among these, C17Z is preferable. By using the curing accelerator, an anisotropic bond magnet excellent in heat resistance is obtained.

The curing accelerator may include a tetrasubstituted phosphonium tetrasubstituted borate. The tetrasubstituted phosphonium tetrasubstituted borate may be a compound represented by the following Formula (I-0).

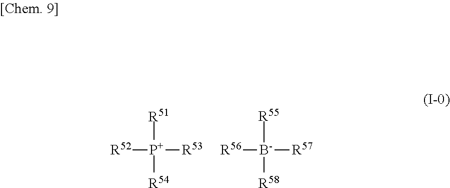

In Formula (I-0), each of R⁵¹ to R⁵⁸ is independently an organic group having 1 to 18 carbon atoms. All of R⁵¹ to R⁵⁸ may be the same, or R⁵¹ to R⁵⁸ may be different from each other.

R⁵¹ to R⁵⁸ in the above General Formula (I-0) may be at least one organic group selected from the group consisting of a substituted or unsubstituted aliphatic hydrocarbon group, a substituted or unsubstituted aliphatic hydrocarbon-oxy group, a substituted or unsubstituted carbonyl group, a substituted or unsubstituted oxycarbonyl group, a substituted or unsubstituted carbonyloxy group, a substituted or unsubstituted aromatic hydrocarbon group, and a substituted or unsubstituted aromatic hydrocarbon-oxy group.

For example, the substituted or unsubstituted aliphatic hydrocarbon group may include aliphatic hydrocarbon groups such as a methyl group, an ethyl group, a propyl group, an isopropyl group, a n-butyl group, a sec-butyl group, a tert-butyl group, a pentyl group, a hexyl group, an octyl group, a decyl group, a dodecyl group, an aryl group, and a vinyl group, and an organic group obtained by substituting these groups with an alkyl group, an alkoxy group, an aryl group, a hydroxyl group, an amino group, a halogen atom, or the like.

The substituted or unsubstituted aliphatic hydrocarbon group includes a substituted or unsubstituted alicyclic hydrocarbon group. For example, the substituted or unsubstituted alicyclic hydrocarbon group may include a cyclopentyl group, a cyclohexyl group, a cycloheptyl group, a cyclopentenyl group, a cyclohexenyl group, and the like, and an organic group obtained by substituting these groups with an alkyl group, an alkoxy group, an aryl group, an aryloxy group, a hydroxyl group, an amino group, a halogen atom, or the like.

For example, the substituted or unsubstituted aromatic hydrocarbon group may include aryl groups such as a phenyl group and a tolyl group; alkyl group-substituted aryl groups such as a dimethylphenyl group, an ethylphenyl group, a butylphenyl group, and a tert-butylphenyl group; alkoxy group-substituted aryl groups such as methoxyphenyl group, ethoxyphenyl group, butoxyphenyl group, and tert-butoxyphenyl group; and an organic group obtained by substituting these groups with an alkyl group, an alkoxy group, an aryl group, an aryloxy group, an amino group, a halogen atom, or the like.

In General Formula (I-0), R⁵¹ to R⁵⁴ may be a substituted or unsubstituted aliphatic hydrocarbon group, and R⁵⁵ to R⁵⁸ may be a substituted or unsubstituted aromatic hydrocarbon group.

For example, tetrasubstituted phosphonium tetrasubstituted borate may be at least one compound selected from the group consisting of tetrabutylphosphonium tetraphenylborate, n-butyltriphenylphosphonium tetraphenylborate, tetraphenylphosphonium tetraphenylborate, tetraphenylborate, trimethylphenylphosphonium diethylmethylphenylphosphonium tetraphenylborate, diallylmethylphenylphosphonium hydroxyethyl)triphenylphosphonium tetraphenylborate, ethyltriphosphonium tetraphenylborate, p-xylenebis(triphenylphosphonium tetraphenylborate), tetraphenylborate, (2-tetraphenylphosphonium tetraethylborate, tetraphenylphosphonium triethylphenylborate, and tetraphenylphosphonium tetrabutylborate. Among these, tetrabutylphosphonium tetraphenylborate is preferable from the viewpoint of storage stability of the compound.

Examples of the compound represented by General Formula (I-0) include PX-4PB (trade name, manufactured by Hokko Chemical Industrial Co., Ltd.).

By using the curing accelerator, an anisotropic bond magnet excellent in heat resistance is obtained. The compound may contain one curing accelerator among those described above. The compound may contain a plurality of curing accelerators among those described above.

The blending amount of the curing accelerator is not particularly limited as long as the curing acceleration effect can be obtained. However, from the viewpoint of the curability of the thermosetting resin and the orientation of the magnetic powder in the magnetic field, the blending amount of the curing accelerator may preferably be 0.1 parts by mass or more and 30 parts by mass or less, and more preferably 1 part by mass or more and 15 parts by mass or less with respect to 100 parts by mass of the epoxy resin. In a case where the blending amount of the curing accelerator is less than 0.1 parts by mass, it is difficult to obtain a sufficient curing acceleration effect. In a case where the blending amount of the curing accelerator is more than 30 parts by mass, the storage stability of the compound is likely to decrease. The content of the curing accelerator is preferably 0.001 parts by mass or more and 5 parts by mass or less with respect to the total mass of the epoxy resin and the curing agent (for example, phenolic resin).

### <Coupling Agent>

The coupling agent may be any coupling agent that reacts with a glycidyl group contained in the resin composition, such as an epoxy resin (epoxy compound). The coupling agent improves the adhesion between the magnetic particles and the resin composition, and improves mechanical strength of the anisotropic bond magnet. The coupling agent that reacts with the glycidyl group may be, for example, a silane-based compound (silane coupling agent). For example, the silane coupling agent may be at least one selected from the group consisting of epoxysilane, mercaptosilane, aminosilane, alkylsilane, ureidosilane, acid anhydride-based silane (for example, silane having succinic anhydride groups), and vinylsilane.

The compound may contain one coupling agent among those described above. The compound may contain a plurality of coupling agents among those described above.

### <Flame Retardant>

For environmental safety, recyclability, moldability, and low cost of the compound, the resin composition may contain a flame retardant. For example, the flame retardant may be at least one compound selected from the group consisting of a bromine-based flame retardant, a phosphorus-based flame retardant, a hydrated metal compound-based flame retardant, a silicone-based flame retardant, a nitrogen-containing compound, a hindered amine compound, an organometallic compound, and an aromatic engineering plastic. The compound may contain one flame retardant among those described above, or may contain a plurality of flame retardants among those described above.

### <Production of Compound>

A compound is obtained by mixing the magnetic powder, the resin composition, and the wax. The mass of each of the magnetic powder, each component constituting the resin composition, and the wax is adjusted to match the composition of the compound described above. The magnetic powder, all the components constituting the resin composition, and the wax may be mixed at once. After a mixture of the magnetic powder and the resin composition is prepared in advance, the mixture and the wax may be mixed.

A compound may be obtained by coating a surface of each magnetic particle constituting the magnetic powder with the resin composition and then mixing the magnetic powder and the wax by the following method.

The resin composition is uniformly stirred in an organic solvent and mixed to prepare a resin solution. The resin solution may contain a curing agent, a curing accelerator, a coupling agent, a flame retardant, a flow aid, a reactive diluent, and the like in addition to the thermosetting resin. The organic solvent is not particularly limited as long as it is a liquid that dissolves the resin composition. For example, the organic solvent may be at least one solvent selected from the group consisting of acetone, N-methylpyrrolidinone (N-methyl-2-pyrrolidone), y-butyrolactone, dimethylformamide, dimethyl sulfoxide, methyl ethyl ketone, methyl isobutyl ketone, toluene, and xylene.

The above resin solution and magnetic powder are stirred and mixed, followed by removal of the organic solvent from the resin solution to obtain a mixed powder containing the magnetic powder and the resin composition. As the organic solvent is removed from the resin solution, the resin composition adheres to a surface of each magnetic particle constituting the magnetic powder. The resin composition may adhere to the entire surface of each magnetic particle. The resin composition may adhere to only a part of the surface of each magnetic particle. The method for removing the organic solvent from the resin solution is not particularly limited. For example, the organic solvent may be removed from the resin solution by drying the mixture of the resin solution and the magnetic powder. For example, the method for drying the resin solution may be vacuum drying.

A compound may be obtained by further mixing the mixed powder containing the magnetic powder and the resin composition with a wax.

### <Production of Tablet>

A tablet containing the compound may be produced by compression molding the compound with which the mold is filled. The size and shape of the tablet are not particularly limited. For example, the tablet may be a cylinder. For example, the diameter of the cylinder may be 5 mm or more, and the height of the cylinder may be 5 mm or more. From the viewpoint of easily maintaining the shape of the tablet, the molding pressure for producing the tablet is preferably 100 MPa or more. In a case where the molding pressure for producing the tablet is too high, the magnetic powder is difficult to rotate and difficult to be oriented in the molding step described above. For this reason, the molding pressure for producing the tablet is preferably 600 MPa or less.

However, the present invention is not necessarily limited to the embodiments described above. Various modifications of the present invention can be made without departing from the gist of the present invention, and such modifications are also included in the present invention.

### EXAMPLES

The present invention will be described in detail with the following Examples and Comparative Examples. The present invention is not limited to the following examples.

### Example 1

A magnetic powder, a thermosetting resin, a curing accelerator, and a wax were mixed in a plastic bottle for 1 hour to prepare a compound (powder) of Example 1. The volume of the plastic bottle was 500 ml.

As the magnetic powder, a SmFeN powder containing Sm₂Fe₁₇N₃ as a main phase was used. The magnetic powder was manufactured by Sumitomo Metal Mining Co., Ltd.

As the thermosetting resin, an epoxy resin and a phenol novolac resin were used.

As the epoxy resin, YX-4000H manufactured by Mitsubishi Chemical Corporation was used. YX-4000H is a biphenyl-type epoxy resin.

As the phenol novolac resin, HP-850N manufactured by Showa Denko Materials Co., Ltd. was used.

As the curing accelerator, C17Z manufactured by Shikoku Chemicals Corporation was used. C17Z is an imidazole-based curing accelerator.

As the wax, Licowax E manufactured by Clariant Plastics & Coatings (Japan) K.K was used. Licowax E is a montanic acid ester. The dropping point of Licowax E is 82° C.

The mass of the magnetic powder in the compound is shown in Table 1 below.

The mass of YX-4000H in the compound is shown in Table 1 below.

The mass of HP-850N in the compound is shown in Table 1 below.

The mass of C17Z in the compound is shown in Table 1 below.

The mass of Licowax E in the compound is shown in Table 1 below.

The unit of mass described in Table 1 below is gram (g).

(M2/M1)×100 is shown in the following Table 1. The definition of (M2/M1)×100 is as described above.

A magnetic compact and an anisotropic bond magnet were prepared from the compound of Example 1 by the following method. As a molding apparatus (hydraulic press apparatus), TM-MPH10525-10A2TM manufactured by TAMAKAWA CO., LTD. was used.

In a supplying step, approximately 2 g of the compound was supplied into a mold of the molding apparatus. The shape of the mold (cavity) was cubic, and the capacity of the mold (cavity) was 7 mm×7 mm×7 mm.

In a molding step, the mold was heated for 3 to 5 minutes until the temperature of the mold reached a molding temperature Tm. The molding temperature Tm was 100° C. That is, the molding temperature Tm was higher than the dropping point (82° C.) of the wax and lower than the thermal curing temperature of the thermosetting resin in the compound.

As the molding step, the following first pressurizing step and second pressurizing step subsequent to the first pressurizing step were performed. In the first pressurizing step, the compound in the mold was compressed at 10 MPa (first pressure P1) for 1 minute while a static magnetic field was applied to the compound in the mold heated at the molding temperature Tm. The intensity of the static magnetic field was maintained at 1.0 T. In the second pressurizing step, the compound (compact) in the mold heated at the molding temperature Tm was compressed at 1000 MPa (second pressure P2) for 5 minutes.

A compact was formed from the compound through the above molding step. In the second pressurizing step, the wax was removed from the compact. During the second pressurizing step, the wax removed from the compact was discharged to the outside of the mold (cavity) through the clearance formed in the mold.

In the cooling step subsequent to the molding step, the mold in which the compact is contained was cooled from 100° C. (molding temperature Tm) to 50° C. (a temperature lower than the dropping point of the wax). The mold was cooled in air for about 10 minutes. After the cooling step, the compact was taken out of the mold.

In a demagnetizing step after the cooling step, the compact was demagnetized by applying a reversed magnetic field to the compact. The direction of the reversed magnetic field was opposite to the direction of the static magnetic field used in the molding step.

In a thermal curing step after the demagnetizing step, the compact was heated at 180° C. (a temperature equal to or higher than the thermal curing temperature of the thermosetting resin) for 20 minutes to obtain a magnetic compact.

In a magnetizing step after the thermal curing step, a magnetic field was applied to the magnetic compact to obtain an anisotropic bond magnet. The direction of the magnetic field used in the magnetizing step was the same as the direction of the static magnetic field used in the molding step.

### <Measurement of Residual Magnetic Flux Density>

A residual magnetic flux density Br (unit: Tesla) of the anisotropic bond magnet was measured. For the measurement of Br, a high-sensitivity conventional electromagnet-type (electromagnetic-type) vibrating sample magnetometer (VSM) was used. The vibrating sample magnetometer was manufactured by TAMAKAWA CO., LTD. The residual magnetic flux density Br of the anisotropic bond magnet of Example 1 is illustrated in Table 1 below.

### <Measurement of Crushing Strength>

The compression pressure was applied to an end surface of the anisotropic bond magnet using a universal compression tester. That is, the compression pressure was applied to the anisotropic bond magnet in the height direction of the anisotropic bond magnet. The compression pressure was increased, and the compression pressure when the anisotropic bond magnet was broken was measured. The compression pressure when the anisotropic bond magnet was broken means crushing strength (unit: MPa). As the universal compression tester, AG-10TRB manufactured by Shimadzu Corporation was used. The crosshead velocity in the crushing strength measurement was 0.5 mm/min. The crushing strength was measured at room temperature. The crushing strength of the anisotropic bond magnet of Example 1 is shown in Table 1 below.

### Example 2

In the production of a compound of Example 2, KIR-30 was used as the thermosetting resin. As described above, KIR-30 is a product manufactured by KYOCERA Corporation. KIR-30 contains a mixture (uncured resin) of an aminophenol adduct of bismaleimide and an epoxy resin.

The mass of KIR-30 in the compound of Example 2 is shown in Table 1 below.

The mass of Licowax E in the compound of Example 2 is shown in Table 1 below.

(M2/M1)×100 of Example 2 is shown in the following Table 1.

A compound, a magnetic compact, and an anisotropic bond magnet of Example 2 were produced by the same method as in Example 1 except for the above matters. Br and crushing strength of the anisotropic bond magnet of Example 2 were measured in the same manner as in Example 1. The measurement results of Example 2 are shown in Table 1 below.

### Example 3

In the production of a compound of Example 3, KIR-30 was used as the thermosetting resin.

The mass of KIR-30 in the compound of Example 3 is shown in Table 1 below.

The mass of Licowax E in the compound of Example 3 is shown in Table 1 below.

(M2/M1)×100 of Example 3 is shown in the following Table 1.

A compound, a magnetic compact, and an anisotropic bond magnet of Example 3 were produced by the same method as in Example 1 except for the above matters. Br and crushing strength of the anisotropic bond magnet of Example 3 were measured in the same manner as in Example 1. The measurement results of Example 3 are shown in Table 1 below.

### Example 4

In the production of a compound of Example 4, KIR-30 was used as the thermosetting resin.

The mass of KIR-30 in the compound of Example 4 is shown in Table 1 below.

The mass of Licowax E in the compound of Example 4 is shown in Table 1 below.

(M2/M1)×100 of Example 4 is shown in the following Table 1.

A compound, a magnetic compact, and an anisotropic bond magnet of Example 4 were produced by the same method as in Example 1 except for the above matters. Br and crushing strength of the anisotropic bond magnet of Example 4 were measured in the same manner as in Example 1. The measurement results of Example 4 are shown in Table 1 below.

### Example 5

The mass of the magnetic powder in the compound of Example 5 is shown in Table 1 below.

The mass of YX-4000H in the compound of Example 5 is shown in Table 1 below.

The mass of HP-850N in the compound of Example 5 is shown in Table 1 below.

The mass of Licowax E in the compound of Example 5 is shown in Table 1 below.

(M2/M1)×100 of Example 5 is shown in the following Table 1.

A compound, a magnetic compact, and an anisotropic bond magnet of Example 5 were produced by the same method as in Example 1 except for the above matters. Br and crushing strength of the anisotropic bond magnet of Example 5 were measured in the same manner as in Example 1. The measurement results of Example 5 are shown in Table 1 below.

### Comparative Example 1

The molding temperature Tm in the molding step of Comparative Example 1 was 60° C. That is, the molding temperature Tm of Comparative Example 1 was lower than the dropping point (82° C.) of the wax.

A compound, a magnetic compact, and an anisotropic bond magnet of Comparative Example 1 were produced by the same method as in Example 1 except for the above matter. Br and crushing strength of the anisotropic bond magnet of Comparative Example 1 were measured in the same manner as in Example 1. The measurement results of Comparative Example 1 are shown in Table 1 below.

### Comparative Example 2

The second pressure P2 in the second pressurizing step in Comparative Example 2 was 500 MPa. During the second pressurizing step of Comparative Example 2, the wax was not discharged to the outside of the mold through the clearance formed in the mold. That is, in the molding step of Comparative Example 2, the wax was not substantially removed from the compact.

A compound, a magnetic compact, and an anisotropic bond magnet of Comparative Example 2 were produced by the same method as in Example 1 except for the above matters. Br and crushing strength of the anisotropic bond magnet of Comparative Example 2 were measured in the same manner as in Example 1. The measurement results of Comparative Example 2 are shown in Table 1 below.

### Comparative Example 3

The second pressure P2 in the second pressurizing step in Comparative Example 3 was 500 MPa. During the second pressurizing step of Comparative Example 3, the wax was not discharged to the outside of the mold through the clearance formed in the mold. That is, in the molding step of Comparative Example 3, the wax was not substantially removed from the compact.

A compound, a magnetic compact, and an anisotropic bond magnet of Comparative Example 3 were produced by the same method as in Example 2 except for the above matters. Br and crushing strength of the anisotropic bond magnet of Comparative Example 3 were measured in the same manner as in Example 1. The measurement results of Comparative Example 3 are shown in Table 1 below.

### Comparative Example 4

The demagnetizing step was not performed in Comparative Example 4. An attempt was made to produce a magnetic compact and an anisotropic bond magnet of Comparative Example 4 by the same method as in Example 1 except for the demagnetizing step. However, in the thermal curing step of Comparative Example 4, the surface of the compact fluffed. As a result, the shape of the compact and the orientation of the magnetic powder in the compact were impaired, and the magnetic compact and the anisotropic bond magnet of Comparative Example 4 could not be produced.

TABLE 1

| | Example | Example | Example | Example | Example | Comparative | Comparative | Comparative | Comparative |
|---|---|---|---|---|---|---|---|---|---|
| | 1 | 2 | 3 | 4 | 5 | Example 1 | Example 2 | Example 3 | Example 4 |
| Magnetic | 980 | 980 | 980 | 980 | 960 | 980 | 980 | 980 | 980 |
| powder [g] | | | | | | | | | |
| YX-4000H [g] | 12.8 | 0 | 0 | 0 | 25.6 | 12.8 | 12.8 | 0 | 12.8 |
| HP-850N [g] | 7.2 | 0 | 0 | 0 | 14.4 | 7.2 | 7.2 | 0 | 7.2 |
| KIR-30 [g] | 0 | 20 | 20 | 20 | 0 | 0 | 0 | 20 | 0 |
| Licowax E [g] | 25 | 30 | 20 | 40 | 30 | 25 | 25 | 30 | 25 |
| CZ17 [g] | 0.2 | 0.2 | 0.2 | 0.2 | 0.2 | 0.2 | 0.2 | 0.2 | 0.2 |
| (M2/M1) × 100 [—] | 2.5 | 3.0 | 2.0 | 4.0 | 3.0 | 2.5 | 2.5 | 3.0 | 2.5 |
| Br [T] | 1.03 | 1.02 | 1.02 | 1.02 | 0.81 | 0.44 | 0.61 | 0.81 | — |
| Crushing | 58 | 37 | 38 | 37 | 54 | 52 | 45 | 29 | — |
| strength [MPa] | | | | | | | | | |

### INDUSTRIAL APPLICABILITY

For example, according to an aspect of the present invention, the anisotropic bond magnet excellent in residual magnetic flux density and mechanical strength is provided.

### REFERENCE SIGNS LIST

2 . . . Compound, 2A . . . Compact, 2B . . . Anisotropic bond magnet, 3 . . . Magnetic particle (magnetic powder), 4 . . . Wax, 5 . . . Thermosetting resin (resin composition), 6 . . . Clearance, 10 . . . Manufacturing apparatus (molding apparatus), c1 . . . First coil, c2 . . . Second coil, d1 . . . Die, H . . . Magnetic field, m . . . Magnetization direction of magnetic particle, M . . . Magnetization direction of anisotropic bond magnet, p1 . . . First punch, p2 . . . Second punch, P1 . . . First pressure, P2 . . . Second pressure.

1. A manufacturing method for a magnetic compact, the method comprising:
a supplying step of supplying a compound containing a magnetic powder, a thermosetting resin, and a wax into a mold;
a molding step of forming a compact from the compound and removing the wax from the compact by compressing the compound in the mold while applying a magnetic field to the compound in the mold heated at a molding temperature Tm;
a demagnetizing step of demagnetizing the compact after the molding step; and
a thermal curing step of heating the compact at a temperature equal to or higher than a thermal curing temperature of the thermosetting resin after the demagnetizing step to obtain the magnetic compact from the compact,
wherein the magnetic powder contains a Sm—Fe—N based permanent magnet, and
the molding temperature Tm is equal to or higher than a dropping point of the wax and lower than the thermal curing temperature of the thermosetting resin.

2. The manufacturing method for the magnetic compact according to claim 1,
wherein the molding step includes a first pressurizing step and a second pressurizing step subsequent to the first pressurizing step,
in the first pressurizing step, a pressure acting on the compound in the mold heated at the molding temperature Tm is maintained at a first pressure P1,
in the second pressurizing step, a pressure acting on the compound in the mold heated at the molding temperature Tm is maintained at a second pressure P2,
the second pressure P2 is higher than the first pressure P1, and
in the second pressurizing step, the wax is removed from the compact.

3. The manufacturing method for the magnetic compact according to claim 1,
wherein, in the molding step, the wax is removed from the compact by continuously increasing a pressure acting on the compound in the mold heated at the molding temperature Tm to a second pressure P2.

4. The manufacturing method for the magnetic compact according to claim 1, the method further comprising
a cooling step of cooling the mold in which the compact is contained from the molding temperature Tm to a temperature lower than the dropping point,
wherein the cooling step is subsequent to the molding step, and
the demagnetizing step is performed after the cooling step.

5. The manufacturing method for the magnetic compact according to claim 1,
wherein a clearance is formed in the mold,
a viscosity of the wax at the molding temperature Tm is lower than a viscosity of the thermosetting resin at the molding temperature Tm, and
in the molding step, the wax removed from the compact is discharged to an outside of the mold through the clearance.

6. The manufacturing method for the magnetic compact according to claim 1,
wherein a total of a mass of the magnetic powder and a mass of the thermosetting resin is represented by M1,
a mass of the wax in the compound is represented by M2, and
(M2/M1)×100 is 2 or more and 10 or less.

7. The manufacturing method for the magnetic compact according to claim 1,
wherein the thermosetting resin contains at least one resin selected from the group consisting of an epoxy resin, a maleimide compound, polyimide, polyamide, and polyamideimide.

8. The manufacturing method for the magnetic compact according to claim 1,
wherein the wax contains a montanic acid ester.

9. A manufacturing method for an anisotropic bond magnet, the method comprising:
the manufacturing method for the magnetic compact according to claim 1; and
further comprising a magnetizing step of magnetizing the magnetic compact to obtain the anisotropic bond magnet.

10. A manufacturing method for an anisotropic bond magnet, the method comprising:
the manufacturing method for the magnetic compact according to claim 4; and
further comprising a magnetizing step of magnetizing the magnetic compact to obtain the anisotropic bond magnet.

11. A manufacturing method for an anisotropic bond magnet, the method comprising:
the manufacturing method for the magnetic compact according to claim 5; and
further comprising a magnetizing step of magnetizing the magnetic compact to obtain the anisotropic bond magnet.

12. A manufacturing method for an anisotropic bond magnet, the method comprising:
the manufacturing method for the magnetic compact according to claim 6; and
further comprising a magnetizing step of magnetizing the magnetic compact to obtain the anisotropic bond magnet.

13. A manufacturing method for an anisotropic bond magnet, the method comprising:
the manufacturing method for the magnetic compact according to claim 7; and
further comprising a magnetizing step of magnetizing the magnetic compact to obtain the anisotropic bond magnet.

14. A manufacturing method for an anisotropic bond magnet, the method comprising:
the manufacturing method for the magnetic compact according to claim 8; and
further comprising a magnetizing step of magnetizing the magnetic compact to obtain the anisotropic bond magnet.
